(19) United States
(12) Patent Application Publication
(10) Pub. No.: US 2008/0069029 A1
(43) Pub. Date: Mar. 20, 2008

(54) Wireless Transit Link Discovery and Establishment

(75) Inventor: Jarry Chow, Kanata (CN)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent, QC (CA)

(21) Appl. No.: 11/577,271

(22) PCT Filed: Oct. 13, 2005
(86) PCT No.: PCT/IB05/03066

§ 371 Date: Apr. 13, 2007

Related U.S. Application Data
(60) Provisional application No. 60/618,215, filed on Oct. 13, 2004.

(51) Int. Cl. H04B 7/24; H04L 12/56; H04Q 7/38

(52) U.S. Cl. 370/328; 370/389

(57) ABSTRACT

The present invention provides a technique for allowing neighboring nodes to dynamically discover the existence of each other and establish transit links therebetween. The discovery process includes providing a channel assessment among a number of communication channels based on channel traffic or characteristics of the channel traffic. Based on the channel assessment, a candidate channel is selected and the mesh node will begin transmitting discovery messages and listening for responses to the discovery messages from neighboring mesh nodes. Upon receipt of a response, the mesh node can determine whether a transit link can and should be established with the neighboring node. During establishment of a transit link, a lower layer communication link is established with the neighboring mesh node for scheduling and authentication of the respective mesh nodes with respect to each other, prior to activation of the transit link itself. The transit link will be used for forwarding data.

### CROSS-REFERENCE TO RELATED APPLICATION

This application claims the benefit of U.S. Provisional patent application Ser. No. 60/618,215 entitled “Transit Link Discovery in a Wireless Mesh Network” that was filed in the U.S. Patent and Trademark Office on Oct. 13, 2004.

### FIELD OF THE INVENTION

The present invention relates to mesh networking, and in particular, to controlling and establishing transit links within a mesh network.

### BACKGROUND OF THE INVENTION

A mesh network generally refers to a group of interworked communication nodes that cooperate to forward packets through the network without influence from a centralized control entity. Forwarding control is distributed among the nodes, wherein each node generally makes autonomous forwarding decisions for received packets based on various criteria.

In a wireless mesh network, all or certain nodes may provide network access for compatible communication terminals through wireless techniques, such as through spread spectrum communications. The connections between nodes may use wired or wireless connections. The wireless connections between the nodes may be implemented using different communication techniques than those used to facilitate access for the communication terminals. For example, wireless access for the communication terminals may be implemented using spread spectrum techniques, wherein communications between nodes may be facilitated using orthogonal frequency division multiple access (OFDM).

The mesh network is connected to a core communication network through one or more boundary nodes, which communicate with proximate communication nodes in generally the same manner in which the communication nodes communicate with each other. Generally, there is a relatively large number of interworked communication nodes forming a given mesh network. Communication links, which are often referred to as transit links, must be established between any two interworked communication nodes. Establishing and controlling transit links has proven cumbersome and inefficient.

The communication nodes may be equipped with multiple directional antennas for better transit link performance, instead of more traditional omni-directional antennas. With directional antennas, communications over different antennas may not detect or reach neighboring communication nodes. As such, attempts to initiate transit links from one directional antenna may occur when a neighboring node is not available to respond or when there is no neighboring node present in the direction of the transmission.

Accordingly, there is a need for a more efficient and effective technique to establish and control transit links between communication nodes within wireless mesh networks. There is further need to establish and control transit links between communication nodes that employ multiple directional antennas.

### SUMMARY OF THE INVENTION

The present invention provides a technique for allowing neighboring nodes in a mesh network to automatically and dynamically discover the existence of each other and establish transit links between any two neighboring nodes. For communications between mesh nodes, omni-directional or directional antennas may be employed. If multiple directional antennas are being used, the present invention will select an antenna to use for the discovery process. The discovery process includes providing a channel assessment among a number of communication channels based on channel traffic or characteristics of the channel traffic. Based on the channel assessment, a candidate channel is selected and the mesh node will begin transmitting discovery messages and listening for responses to the discovery messages from neighboring mesh nodes. Upon receipt of a response, the mesh node can determine whether a transit link can and should be established with the neighboring node. During establishment of a transit link, a lower layer communication link is established with the neighboring mesh node for scheduling and authentication of the respective mesh nodes with respect to each other, prior to activation of the transit link itself. The transit link will be used for forwarding data in association with a communication session involving two or more communication terminals. The data may represent traditional data, audio, video, multimedia, or voice information, as well as other forms of data.

The different nodes may cycle through using different dwell periods during which the discovery process takes place. The dwell periods will generally have different lengths, which are related to the amount of time that a neighboring node, which is using a shorter dwell period, would take to cycle through the discovery process for each of its multiple antennas. Accordingly, there is a greater likelihood that the neighboring nodes that are involved in discovery processes will cross each other's communication paths.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a mesh networking environment according to one embodiment of the present invention.

FIG. 2 depicts the transit link coverage areas of a mesh node according to one embodiment of the present invention.

FIG. 3 is a block representation of multiple mesh nodes, which communicate with each other via directional antennas.

FIGS. 4A-4C provide a flow diagram illustrating the operation of a mesh node according to one embodiment of the present invention.

FIG. 5 is a communication flow diagram illustrating an exemplary messaging sequence when an isolated mesh node is attempting to establish a transit link with another mesh node connected to the mesh networking network.

FIG. 6 is a communication flow diagram illustrating an exemplary messaging sequence when a connected mesh node is attempting to establish a transit link with another mesh node connected to the mesh networking network.

FIG. 7 is a block representation of a mesh node according to one embodiment of the present invention.

FIG. 8 is a block representation of a boundary mesh node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides an efficient and effective technique for allowing compatible mesh nodes in a mesh network to discover one another and establish a transit link between the two mesh nodes in an automated fashion. The technique is particularly beneficial when the mesh nodes are equipped with directional antennas, which form directional beam coverage areas within which communications are possible. Prior to delving into the details of the present invention, an overview of a mesh network is provided.

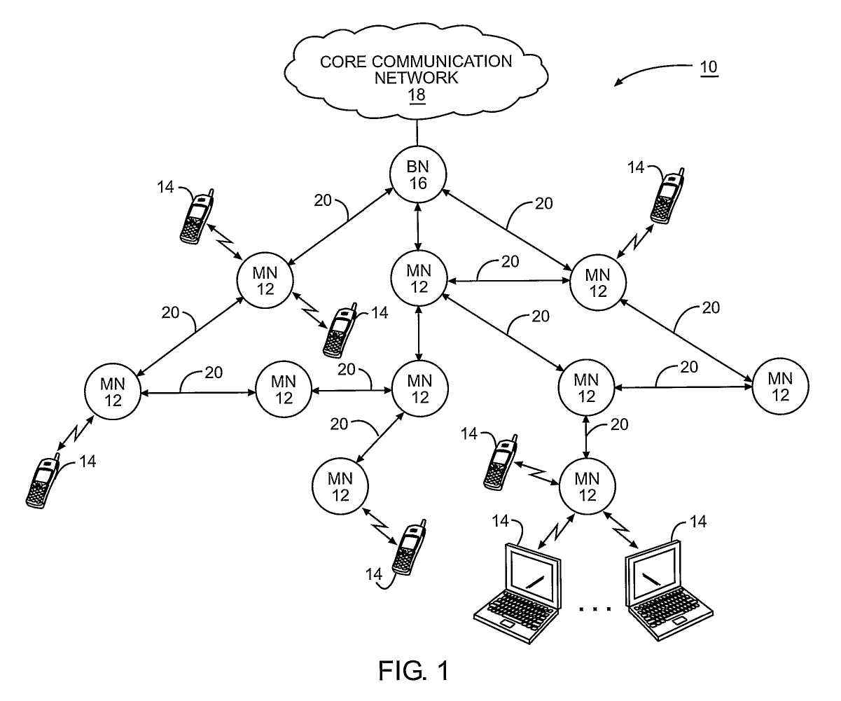

With reference to FIG. 1, a mesh network 10 will include a number of mesh nodes (MNs) 12, which are capable of communicating with neighboring mesh nodes 12 as well as with various types of communication terminals 14, such as mobile telephones, personal digital assistants, and personal computers. The mesh network 10 will also include at least one boundary node (BN) 16. The mesh nodes 12 and the boundary node 16 may communicate with its neighbors via transit links 20. As illustrated, the transit links 20 may not be established with all of the neighbors of a particular mesh node 12 or boundary node 16. Further, just because two mesh nodes 12 or a mesh node 12 and a boundary node 16 are within communication range of each other, a transit link 20 need not be established, depending on the configuration of the mesh network 10. In many configurations, the boundary node 16 provides a gateway to a core communication network 18, which may act as a backbone network connecting any number of mesh networks 10 and other types of networks together to form a common communication system. The mesh nodes 12 and the boundary node 16 may be associated with any number of antennas (not shown), which are capable of providing omni-directional or directional coverage, as will be described further below. In many instances where a mesh node 12 or a boundary node 16 is added to the mesh network 10 or used to replace an existing mesh node 12 or boundary node 16, there is a need for the mesh node 12 or boundary node 16 to discover its neighbors (i.e., become informed as to the existence of the node) and establish transit links 20 if and as appropriate. The boundary node 16 intrinsically is generally connected to the network by virtue of having connectivity to the core communication network 18. In addition, the boundary node 16 may have a pre-established trust relationship with the operator of the mesh network and is able to authenticate the validity of transit links that it may establish with one or more mesh nodes 12.

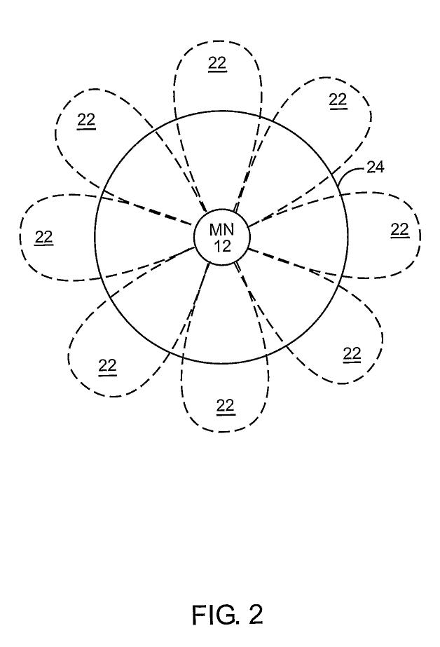

Although the present invention is applicable to omni-directional antenna configurations, the use of the present invention is particularly beneficial in embodiments where the mesh nodes 12 and perhaps the boundary node 16 incorporate directional antennas. With reference to FIG. 2, a mesh node 12 is illustrated along with the transit link coverage areas 22 provided by beamformed, directional antennas. As illustrated, the transit link coverage areas 22 are effectively directional lobes extending outward from the mesh node 12 in different directions and substantially isolated areas. The mesh node 12 may have an access coverage area 24, which may be omni-directional, for facilitating access to the mesh node 12 by the communication terminals 14.

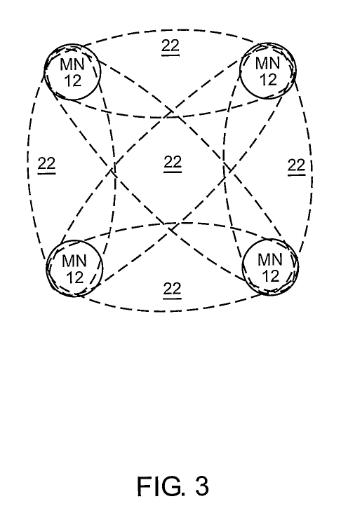

With reference to FIG. 3, four mesh nodes 12 are illustrated wherein various transit link coverage areas 22 are illustrated. Wherever two or more mesh nodes 12 fall within a given transit link coverage area 22, a transit link 20 may be established, but again does not need to be established. The present invention provides a technique for allowing the mesh nodes 12 to discover neighboring mesh nodes 12 (or boundary nodes 16) that are in common transit link coverage areas 22, and determine whether a transit link 20 should be established. If the criteria for establishment of a transit link 20 are met, a transit link 20 will be established.

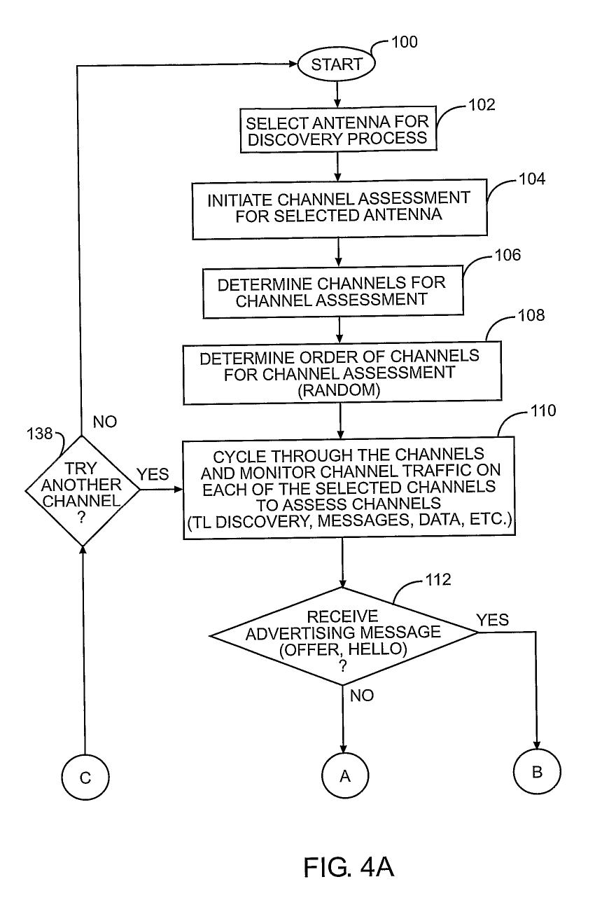

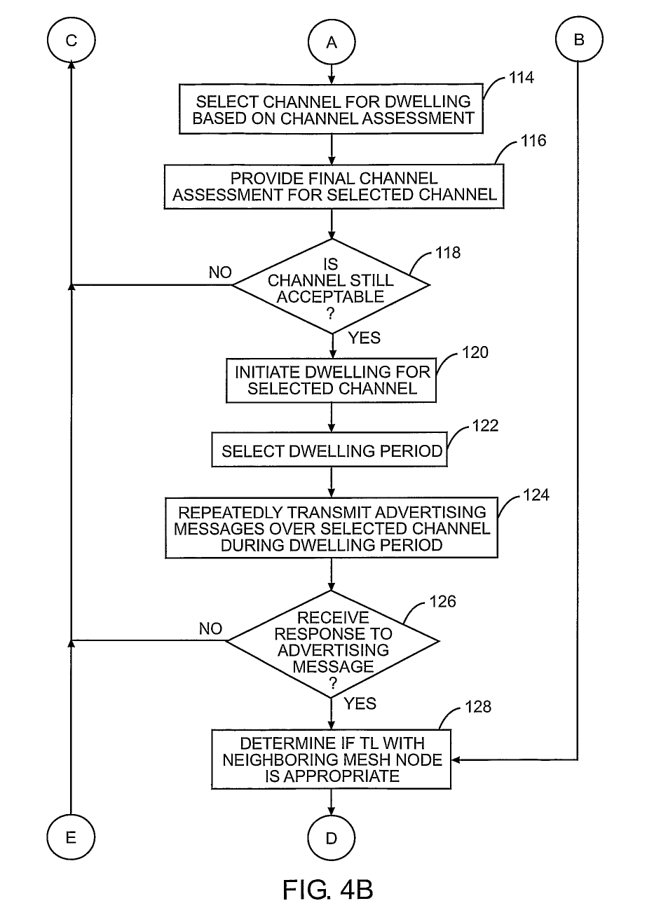

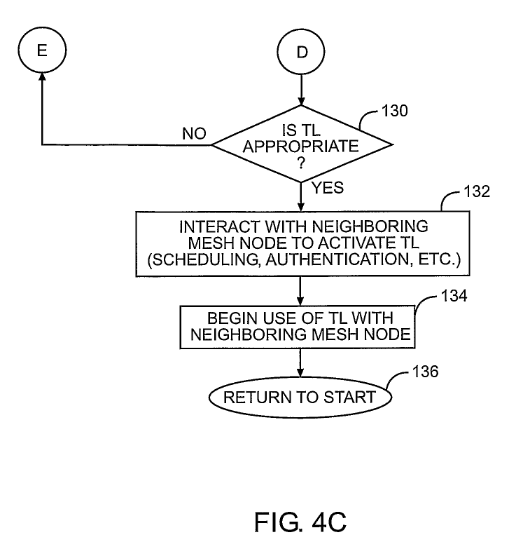

Turning now to FIGS. 4A-4C, a flow diagram is provided for discovering and establishing neighboring mesh or boundary nodes 12, 16 and establishing transit links 20 therebetween, if so desired. In this embodiment, assume that there are multiple antennas associated with a given mesh node 12, and that the following process is systematically, and perhaps randomly, applied to each of the antennas for the mesh node 12. The process starts (step 100) when an antenna is selected for the discovery process (step 102). For the following discussion, neighboring nodes to the mesh node 12 of reference may be mesh nodes 12 or a boundary node 16. Further, the following process is equally applicable to a boundary node 16 that is attempting to discover neighboring mesh nodes 12 and establish transit links 20 with one or more of the mesh nodes 12.

Once an antenna is selected for the discovery process, channel assessment is initiated (step 104), since most antennas will support any number of channels given the multiple access technique employed. Initially, the channels for which channel assessment is provided are determined (step 106) and then the order in which the channel assessment is provided for the selected channels is determined (step 108). In one embodiment, the order in which the channels are provided for channel assessment is random, such that other mesh nodes 12 implementing the same process will have a greater likelihood of establishing other transit links on other channels thereby mitigating radio frequency interference between transit links, which will become more clear as the process is described in greater detail. However, other channel selection schemes can be employed. Once the order for channel assessment is determined, the mesh node 12 will cycle through the channels and monitor channel traffic on each of the selected channels to assess the channels (step 110). The process of monitoring the channel traffic may be implemented in various ways, and will ultimately provide sufficient information to allow the mesh node 12 to determine whether a neighboring node exists and whether an attempt to initiate communications with the neighboring node is desirable or whether a channel with the least potential interference should be selected on which to wait for a neighboring node to discover it. Initiating communications will allow the mesh node 12 to determine whether a transit link 20 can or should be established.

The channel traffic may take various forms, and the way in which the channel traffic is monitored may vary. For example, the channel traffic may include actual data traffic being forwarded by the neighboring mesh node 12, as well as signaling messages provided by the neighboring mesh node 12. In particular, these signaling messages may include discovery messages, which are part of the process for discovering and establishing transit links 20. These discovery messages may take many forms and will be described in greater detail below. In the meantime, the discovery messages are generally those provided by neighboring nodes to alert other nodes of the presence of the neighboring node, or actual attempts to establish transit links 20 with the neighboring node. The data traffic may include traditional data, voice, audio, video, or multimedia information that is being forwarded as part of an existing communication session between one of the communication terminals 14 and another device on the mesh network 10 or accessible via the core communication network 18.

In addition to monitoring the content of the channel traffic, the mesh node 12 may also monitor characteristics of the channel traffic. These characteristics may include the relative signal strength or interference associated with the channel traffic. The signal strength and interference are often good indicators of the channel quality and the ability to establish a transit link 20 with the neighboring node. Further, the monitoring of the channel traffic may include monitoring to determine the relative volume of traffic, number of existing transit links 20 supported by the neighboring node, data rates, or the number of transit links 20 needed at the current mesh node 12 or the neighboring node. Based on the content of the channel traffic, characteristics of the channel traffic, or the relative amount of channel traffic, the mesh node 12 can identify and perhaps prioritize channels in which transit links 20 with a given neighboring node may be desirable. During this process, certain channels may be deemed completely unacceptable, while others are given a relative priority with respect to one another. During channel assessment, the mesh node 12 may be configured to detect certain advertising messages, which were transmitted by a neighboring node (step 112). At this point, assume that no advertising messages were received during channel assessment.

Based on channel assessment, a channel is selected for dwelling (step 114). In general, dwelling is a period during which the mesh node 12 attempts to communicate with the neighboring node (or nodes) over a given channel by transmitting, receiving, or otherwise exchanging advertising messages with the neighboring node. In one embodiment, the nearest neighbors to a mesh node 12 are given priority. Therefore, the “best” channel for communicating with the nearest neighbor is selected. The best channel may be the one where the channel traffic had the greatest signal strength or carrier-to-interference ratio. Alternatively, the best channel may include a channel where certain discovery messages of interest were recognized. Different criteria can be established for determining what is “best,” and it is to be appreciated that such criteria can change over time and in accordance with such circumstances as time of day, network traffic, and the like. The presence of discovery messages may be indicative of the neighboring node concurrently trying to evaluate its neighbors, which may include the mesh node 12. Those skilled in the art will recognize that there are limitless ways in which to determine the most suitable channel for dwelling. Prior to initiating dwelling, a final channel assessment for the selected channel may be provided, since channel conditions or channel traffic may have changed during the assessment and selection process (step 116). If a channel is still acceptable (step 118), dwelling is initiated for the selected channel (step 120). A dwelling period may be selected (step 122).

As indicated above, the mesh nodes 12 will systematically select different antennas and then provide channel assessment and dwelling for the selected antennas. To increase the likelihood of the various mesh nodes 12 effectively crossing each other's communication paths, different dwelling periods may be selected at different times, either in a pre-defined order or in a random order. In one embodiment, mesh nodes 12 may cycle between long and short dwelling periods, wherein the long dwelling periods are effectively long enough to allow a neighboring node operating in a short dwelling period to cycle through all of its antennas and provide the channel assessment with a short dwelling period for each antenna, and wherein the long dwelling periods are extended by a random increment beyond this minimum duration such that cycles between mesh nodes 12 are not synchronized. As such, the mesh node 12 operating at the long period will give its neighboring node sufficient time to effectively cycle through all of its antennas and provide channel assessment and dwelling. Since the nodes alternate between long and short periods and the duration of such alternation is not synchronized between mesh nodes 12, the likelihood that neighboring mesh nodes 12 will cross communication paths is significantly enhanced.

Once the dwelling period is selected (step 122), the mesh node 12 will repeatedly transmit advertising messages over the selected channel throughout the dwelling period (step 124) or until a response to one of the advertising messages is received (step 126). Based on the received response to the advertising message, pre-existing configuration information, or any other available established criteria, the mesh node 12 will determine if a transit link 20 with the neighboring node is appropriate (step 128). If the transit link 20 is appropriate (step 130), the mesh node 12 will interact with the neighboring node to activate the transit link 20 (step 132) and then begin use of the transit link 20 with the neighboring mesh node 12 to facilitate forwarding traffic throughout the mesh network 10 (step 134).

In one embodiment, activating a transit link 20 involves the preparation of the transit link 20 as a point-to-point link between the mesh nodes 12 for communications at the link layer only. Such activation may include initial scheduling of future messages to effectively establish the link layer point-to-point link, keep the point-to-point link available, or provide any necessary handshake, key exchange, or the like necessary to facilitate communications at the link layer. Once the point-to-point link is activated, the higher layer transit link 20 establishment may be provided. The establishment of the transit link 20 may require authentication procedures for each of the mesh nodes 12 that will form the transit link 20. Once the authentication procedure or any other higher layer procedures are complete, the transit link 20 can be formally declared as established and made available for higher layer data transfer, wherein traffic can be exchanged over the transit link 20 to facilitate forwarding throughout the mesh network 10. The transit link 20 may be established on the selected channel that was used for dwelling, and that supported the initial exchange of discovery messages to effectively initiate communications between the mesh nodes 12. In another embodiment, more complex channel management and selection schemes may be employed, in which an agreement to use one or more other or additional channels for the exchange of discovery messages or establishment of the transit links 20.

At this point, the entire process may repeat by returning to the start (step 136) and selecting another antenna to initiate another discovery process. Throughout the process, various occurrences may end the process or otherwise alter the basic process flow. For example, if an advertising message is received from a neighboring node when the channel assessment is taking place (step 112), the mesh node 12 may immediately jump to determining if a transit link 20 with a neighboring mesh node 12 is appropriate (step 128), and if appropriate (step 130), attempt to activate the transit link 20 by interacting with the neighboring node (step 132). Further, if the final channel assessment for the selected channel (step 116) indicates that the channel is no longer acceptable (step 118), the mesh node 12 may try another channel based on the channel assessment results (step 138) and begin assessing the other channel originally selected for channel assessment. Alternatively, the mesh node 12 may simply select another antenna and begin the overall process again (step 102). These options are also available if no responses are received to the advertising messages sent during the dwelling period, or if the neighboring mesh node 12 is determined to be one with which a transit link 20 should not be established (steps 126 and 130).

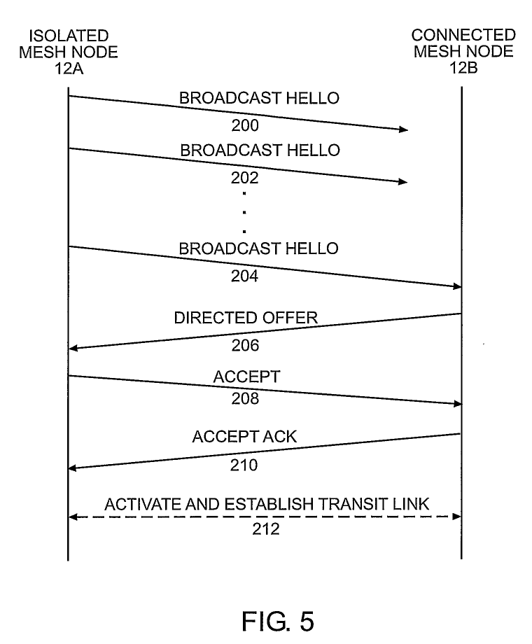

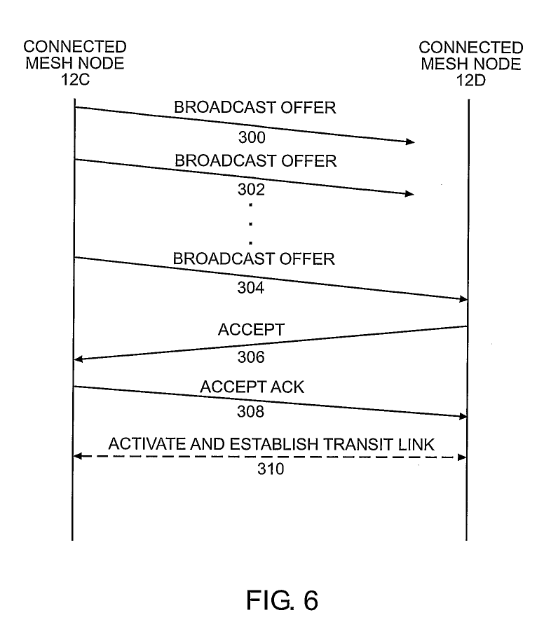

The discovery messages, including any advertising messages, may provide various functions and take any number of forms. The initial advertising messages exchanged between mesh nodes 12 (and perhaps boundary nodes 16) may take many forms. For example, different messages may be associated with mesh nodes 12 having different status. A mesh node 12 that is already connected to the mesh network 10 may send an Offer message to initiate the communication phase of the discovery process. An isolated mesh node 12, which is not connected to any neighboring nodes and is thus not connected to the mesh network 10, may initiate communications in the discovery process by transmitting a Hello message. An exemplary communication flow for a discovery process for an isolated mesh node 12A is provided in FIG. 5, and for a connected mesh node 12C in FIG. 6. Isolated mesh nodes 12 arise, for example, in instances of their introduction to the network, as well as during a return to operation after a period of inactivity (as can occur with servicing, software upgrades, etc.).

With particular reference to FIG. 5, assume an isolated mesh node 12A is engaged in a discovery process with a connected mesh node 12B. After running through the channel assessment process and selecting a channel for dwelling, the isolated mesh node 12A will begin systematically transmitting Hello messages (steps 200-204). Assuming the first two Hello messages (steps 200 and 202) are not received and the third Hello message (step 204) is received by connected mesh node 12B, connected mesh node 12B will process the Hello message and send a Directed Offer message to isolated mesh node 12A (step 206). The Hello message will allow connected mesh node 12B to detect that isolated mesh node 12A is in fact isolated from the mesh network 10, and should be given priority in an attempt to connect to the mesh network 10. As such, the Directed Offer message is not a generic broadcast of an Offer message, but instead is specifically intended for isolated mesh node 12A to trigger a process for activating the link layer communications link and establishing the transit link 20. Isolated mesh node 12A will respond to the Directed Offer message by sending an Accept message back to connected mesh node 12B (step 208), which will reply with an Accept Acknowledgement (ACK) message (step 210). At this point, isolated mesh node 12A and connected mesh node 12B can activate and establish the transit link 20 (step 212).

Turning now to FIG. 6, assume that mesh nodes 12C and 12D are both connected to the mesh network 10, and are merely running through the discovery process to determine whether additional transit links 20 should be established. As such, connected mesh node 12C may send Broadcast Offer messages over the selected channel in a systematic fashion (steps 300, 302, and 304). Assuming the third Broadcast Offer message is actually received by connected mesh node 12D (step 304), connected mesh node 12D will recognize that the Broadcast Offer message is indicative that connected mesh node 12C is in fact connected to the mesh network 10. As such, the internal determination of how to interact with connected mesh node 12C by connected mesh node 12D may be different than if connected mesh node 12C was broadcasting a Hello message, which would indicate it was isolated from the mesh network 10. Regardless of the processing criteria, connected mesh node 12D will respond with an appropriate Accept message (step 306), wherein connected mesh node 12C will reply with an Accept Acknowledgement message (step 308). At this point, connected mesh node 12C and connected mesh node 12D can activate and establish a transit link 20 (step 310).

The discovery messages, including the advertising messages, may include sequence numbers, which are incremented with each successive message. In one embodiment, the sequence is always initiated by a broadcast message, such as a Broadcast Hello or a Broadcast Offer message. The sequence number allows identification and proper termination of proper message sequences to ensure robust and proper behavior under most if not all conditions. A common sequence number may be applied for any particular message sequence. Alternatively, the original sequence number may be incremented or modified with each successive message in a known manner to not only keep track of the relation of the relative messages, but also keep track of the order in which they were delivered.

To improve network security, and in particular to avoid replay-type attacks in which a malicious intruder can record and play back discovery messages with the aim of disrupting normal discovery operation, the present invention may tag each instance of a discovery message with a unique and/or random number. A proper response or reply would contain the unique and/or random number or a function thereof. The random number and any resulting numbers and message sequence may be maintained at the neighboring mesh nodes 12 to aid in detecting an attempt to replay the message sequence. A pair of random number tags may serve as a signature to help identify replayed messages. Any messages not containing an expected tag value, or messages containing an old tag value, are deemed invalid and effectively dropped. In one embodiment, transit links 20 are not formed between two boundary nodes 16. As such, boundary nodes 16 may be configured not to accept Offer messages, and are only configured to initiate Offer messages.

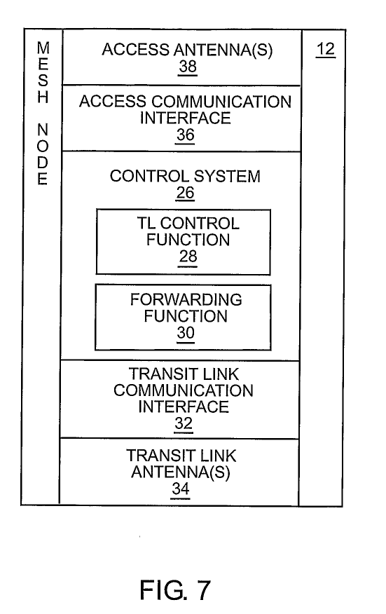

With reference to FIG. 7, a block representation of a mesh node 12 is illustrated. The mesh node 12 may contain a control system 26 having a transit link control function 28 capable of facilitating the discovery and establishment process described above, as well as a forwarding function 30 to facilitate forwarding of data once transit links 20 are established. The control system 26 may be associated with a transit link communication interface 32, which supports any number of omni-directional or directional transit link antennas 34. The control system 26 may also be associated with an access communication interface 36 associated with any number of omni-directional or directional access antennas 38. Those skilled in the art will recognize that the access communication interface 36 and the transit link communication interface 32 may be integrated along with their respective antennas.

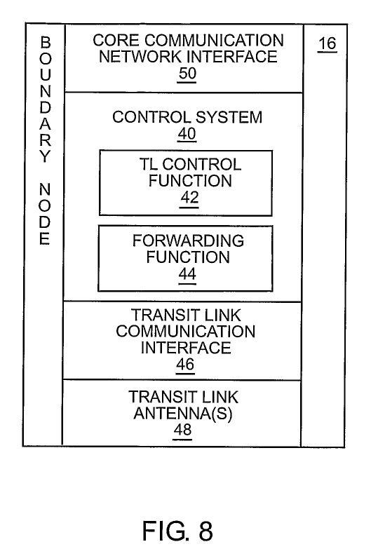

With reference to FIG. 8, a block representation of a boundary node 16 is illustrated. The boundary node 16 may contain a control system 40 having a transit link control function 42 capable of facilitating the discovery and establishment process described above, as well as a forwarding function 44 to facilitate forwarding of data once transit links 20 are established. The control system 42 may be associated with a transit link communication interface 46, which supports any number of omni-directional or directional transit link antennas 48. The control system 40 is also associated with a core communication network interface 50, which is capable of facilitating communications with the core communication network 18 through wired or wireless means. Those skilled in the art will recognize that the transit link communication interfaces 32, 46 of the mesh node 12 and the boundary node 16, respectively, may also support wired access in addition to or in lieu of a wireless interface.

Those skilled in the art will recognize improvements and modifications to the preferred embodiments of the present invention. All such improvements and modifications are considered within the scope of the concepts disclosed herein and the claims that follow.

1. A method for allowing a mesh node to discover a neighboring mesh node in a mesh network comprising:
providing a channel assessment for a plurality of communication channels based on channel traffic or characteristics of the channel traffic present on the plurality of communication channels;
selecting a candidate channel from the plurality of communication channels based on the channel assessment;
transmitting a discovery message over the candidate channel; and
receiving a response to the discovery message from the neighboring mesh node, wherein receiving the response is indicative of being able to establish a transit link with the neighboring mesh node.

2. The method of claim 1 further comprising determining whether to establish the transit link with the neighboring mesh node.

3. The method of claim 1 further comprising establishing the transit link with the neighboring mesh node.

4. The method of claim 3 wherein establishing the transit link further comprises:
activating a lower layer communication link with the neighboring mesh node for link layer communications; and
activating a higher layer communication link with the neighboring mesh node to represent the transit link for data transfer.

5. The method of claim 3 further comprising interacting with the neighboring mesh node to establish a schedule for further communications related to establishing the transit link.

6. The method of claim 3 further comprising interacting with the neighboring mesh node to facilitate mutual authentication.

7. The method of claim 1 wherein the transit link is established on the candidate channel.

8. The method of claim 1 wherein the transit link is established on a channel other than the candidate channel.

9. The method of claim 1 wherein providing the channel assessment comprises cycling through at least some of the plurality of communication channels and analyzing the channel traffic or characteristics of the channel traffic on each of the cycled plurality of communication channels.

10. The method of claim 9 wherein analyzing the channel traffic comprises detecting discovery messages related to other nodes, including the neighboring mesh node, discovering one another or establishing transit links.

11. The method of claim 9 wherein the characteristics of the channel traffic bear on at least one of the group consisting of signal strength, interference, and traffic volume.

12. The method of claim 1 further comprising selecting a dwelling period having a defined length during which the discovery message is repeatedly transmitted.

13. The method of claim 12 wherein the dwelling period is selected based on a possible discovery process being implemented by the neighboring node.

14. The method of claim 13 wherein the dwelling period is based on an amount of time the neighboring node takes to provide a discovery process for a plurality of antennas.

15. The method of claim 1 wherein the discovery message is indicative of the mesh node being isolated from the mesh network.

16. The method of claim 1 wherein the discovery message is indicative of the mesh node being connected to the mesh network.

17. The method of claim 1 further comprising:
receiving a discovery message from the neighboring mesh node during the channel assessment; and
interacting with the neighboring mesh node to establish the transit link.

18. The method of claim 1 wherein the mesh node provides a plurality of directional antennas providing directional coverage areas in different directions, and further comprising systematically attempting to discover neighboring nodes and establish transit links with the neighboring nodes for each of the plurality of antennas.

19. The method of claim 1 wherein the transit link is a communication link within the mesh network used for forwarding traffic, which is part of a communication session between two communication terminals.

20. The method of claim 1 further comprising facilitating communications with communication terminals to provide access to the mesh network for the communication terminals.

21. The method of claim 20 further comprising facilitating communications for forwarding data to and from other neighboring nodes in the mesh network.

22. A mesh node adapted to discover a neighboring mesh node in a mesh network comprising:
a first communication interface adapted to facilitate communications with other mesh nodes, including the neighboring mesh node, which form part of the mesh network;
a second communication interface adapted to facilitate communications with communication terminals requiring access to the mesh network; and
a control system associated with the first and second communication interfaces and adapted to:
provide a channel assessment for a plurality of communication channels based on channel traffic or characteristics of the channel traffic present on the plurality of communication channels;
select a candidate channel from the plurality of communication channels based on the channel assessment;
transmit a discovery message over the candidate channel; and
receive a response to the discovery message from the neighboring mesh node, wherein receiving the response is indicative of being able to establish a transit link with the neighboring mesh node.

23-42. (canceled)
